(19) United States
(12) Patent Application Publication
(10) Pub. No.: US 2022/0146989 A1
(43) Pub. Date: May 12, 2022

(54) EXTENSION MODULE, INDUSTRIAL EQUIPMENT, AND ESTIMATION METHOD

(71) Applicant: Kabushiki Kaisha Yaskawa Denki, Kitakyushu-shi (JP)

(72) Inventors: Yasufumi YOSHIURA, Kitakyushu-shi (JP); Minoru KOGA, Kitakyushu-shi (JP); Toshinobu KIRA, Kitakyushu-shi (JP)

(21) Appl. No.: 17/580,582

(22) Filed: Jan. 20, 2022

Related U.S. Application Data
(63) Continuation of application No. PCT/JP2020/028508, filed on Jul. 22, 2020.

(30) Foreign Application Priority Data
Jul. 22, 2019 (JP) 2019-134347

(51) Int. Cl. G05B 13/02

(52) U.S. Cl. CPC G05B 13/027

(57) ABSTRACT

Provided is an extension module which is an extension module which is to be connected to an external terminal of an industrial equipment, and includes at least a processor and a memory. The memory stores a machine learning model for estimating at least one of a parameter of the industrial equipment and an internal state of a device controlled by the industrial equipment, and the processor performs learning of the machine learning model with information obtained from the industrial equipment as teacher data.

### CROSS-REFERENCE TO RELATED APPLICATION

This application is a continuation under 35 U.S.C. 120 of International Application PCT/JP2020/028508 having the International Filing Date of Jul. 22, 2020 and having the benefit of the earlier filing date of Japanese Application No. 2019-134347, filed on Jul. 22, 2019. Each of the identified applications is fully incorporated herein by reference.

### BACKGROUND OF THE INVENTION

### 1. Field of the Invention

The present invention relates to an extension module, an industrial equipment, and a method of estimating a parameter of an industrial equipment or an internal state of a device controlled by the industrial equipment.

### 2. Description of the Related Art

In recent years, technologies in the field of artificial intelligence (AI) have advanced, and utilization fields and applications thereof are expanding wide. A core technology among those is a technology called “deep learning.” Building and execution of AI by deep learning requires parallel arithmetic processing on a large scale, and a high arithmetic processing capability is accordingly demanded of a computer to be used.

At the same time, a single-board computer used in an embedded device or the like, or a similar small-sized computer is not so high in computing capability, and may lack a capability to execute an AI program by deep learning in which a large amount of computing is required. For that reason, an external device that adds a computing capability suitable for AI programs to the embedded device is commercially available. For example, an external visual processing unit (VPU) is usable by connecting the external VPU to a universal serial bus (USB) port of the small-sized computer.

The external device described above is a general-purpose product, and only provides an expanded computing capability. A general knowledge and skill of AI programming and understanding of a software development kit (SDK) provided for the external device are therefore required in order to use the external device. AI programming suited to an intended use is required to be executed on one's own.

In an industrial equipment including a factory automation (FA) equipment, which is a programmable logic controller (PLC), a servo controller, or the like, the computing capability of the equipment is determined by weighing against cost, power consumption, and others, and therefore hardly exceeds a level secured as a capability required to run the industrial equipment. Generally speaking, the industrial equipment does not have much computing capability to spare.

In JP 2018-152012 A, there is disclosed a machine learning device which obtains, by machine learning, a feedforward coefficient in a servo control device, which is a type of industrial equipment. The servo control device and the machine learning device disclosed in the literature are connected to each other by a local area network (LAN) built inside a factory, the Internet, a public telephone network, or a similar information communication network.

When AI technology is to be applied to estimation of a parameter suitable for a mode of utilization of an industrial equipment, or an internal state of a device controlled by the industrial equipment, a computing capability and a memory capacity that are provided by the industrial equipment on its own are insufficient. In addition, it is not often that the industrial equipment is connected to a general information communication network, and communication between the industrial equipment and a computer having a high computing capability via an information communication network is therefore not always possible.

Even with the industrial equipment connected to a suitable information communication network, not all technical persons in the FA field who regularly use the industrial equipment have professionally been trained in AI programming and, even when personnel professionally trained in AI programming are successfully secured, it is impractical to perform programming for each varying mode of utilization of the industrial equipment which varies depending on the scene of utilization.

### SUMMARY OF THE INVENTION

According to one aspect of the present invention, there is provided an extension module to be connected to an external terminal of a first piece of industrial equipment, the extension module including at least a processor and a memory, wherein the memory is configured to store a machine learning model for estimating at least one parameter of the first piece of industrial equipment or estimating an internal state of a device controlled by the first piece of industrial equipment, and wherein the processor is configured to perform learning of the machine learning model with information obtained from the first piece of industrial equipment as teacher data.

According to one aspect of the present invention, there is further provided a method of estimating a parameter of a first piece of industrial equipment or an internal state of a device controlled by the first piece of industrial equipment, the method including: connecting an extension module to an external terminal of the industrial equipment, the extension module including at least a processor and a memory; and executing a machine learning method in which the processor executes learning of a learning model stored in the memory to estimate at least one of the parameter of the first piece of industrial equipment or the internal state of the device controlled by the first piece of industrial equipment, with information obtained from the first piece of industrial equipment as teacher data.

### BRIEF DESCRIPTION OF THE DRAWINGS

FIG. 1 is an overall perspective view of an industrial equipment, an extension module connected to the industrial equipment, and a controlled device to be controlled by the industrial equipment.

FIG. 2 is a schematic block diagram for illustrating hardware configurations of the industrial equipment, the extension module, and the controlled device.

FIG. 3 is a function block diagram for illustrating internal configurations of the industrial equipment and the extension module connected to each other, with attention focused on functions of the industrial equipment and the extension module.

FIG. 4 is a function block diagram for illustrating an internal configuration of the industrial equipment, with a learned machine learning model included therein.

FIG. 5 is a flow chart for illustrating steps from performing of machine learning to estimation of a parameter of the industrial equipment, or estimation of an internal state of the controlled device.

FIG. 6 is a function block diagram for illustrating industrial equipment and an extension module according to a second embodiment of the present invention.

FIG. 7 is a function block diagram for illustrating industrial equipment and an extension module according to a third embodiment of the present invention.

FIG. 8 is a flow chart for illustrating steps of performing learning on a machine learning model in the third embodiment of the present invention.

FIG. 9 is a flow chart for illustrating steps of estimating a parameter, or an internal state of a device, with the use of a learned machine learning model in the third embodiment of the present invention.

FIG. 10 is a flow chart for illustrating steps of automatically selecting and obtaining a model from a plurality of machine learning models in a fourth embodiment of the present invention.

### DESCRIPTION OF THE EMBODIMENTS

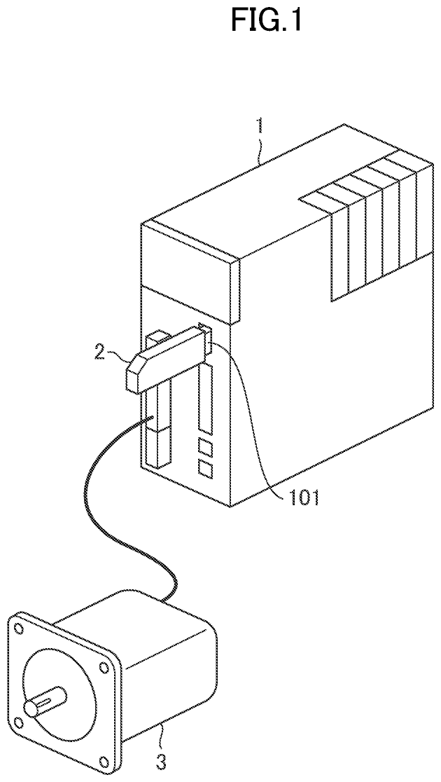

An industrial equipment 1 and an extension module 2 according to a first embodiment of the present invention, and an estimation method according to the first embodiment which is a method of estimating an internal state of the industrial equipment 1, or an internal state of a controlled device 3 to be controlled by the industrial equipment 1 by using the industrial equipment 1 and the extension module 2, are described below with reference to FIG. 1 to FIG. 5.

FIG. 1 is an overall perspective view of the industrial equipment 1, the extension module 2 connected to the industrial equipment 1, and the controlled device 3 to be controlled by the industrial equipment 1. In embodiments described in the present application, the industrial equipment is described as a servo controller, and the following description takes a servo controller as an example of the industrial equipment 1. The “industrial equipment” in the present application refers to a piece of equipment which is usable for FA, and has a function of controlling some other device (the controlled device 3) or exchanging information with another device, and may be a PLC, a single-board microcomputer, or the like other than a servo controller. The actual use of the industrial equipment 1 is not limited to FA, and may be embedded and used in various devices including vehicles and amusement machines as well as production equipment.

The controlled device 3 is a device controlled by the industrial equipment 1, or a device to and from which information indicating a state of the device is input and output. Here, a servo motor is described as the controlled device 3, and the following description takes a servo motor as an example of the controlled device 3. The controlled device 3 may be a rotary electric motor of another form (for example, a stepping motor), a type of actuator out of various types, a switch, a sensor, or the like. It is not required to limit the number of controlled devices 3 connected to the industrial equipment 1 to one controlled device 3, and more than one controlled device 3 may be connected.

The industrial equipment 1 is provided with an external terminal 101 for connecting to a suitable external device. The external terminal 101, which is provided on a front surface of the industrial equipment 1 in FIG. 1, may be provided on another surface, for example, a rear surface, or more than one external 101 may be prepared. The external terminal 101 is a connection terminal for inputting/outputting information between the industrial equipment 1 and a suitable external terminal, and may be compliant with any standard. In this embodiment, the external terminal 101 is a USB terminal. However, the external terminal 101 may be a terminal compliant with a suitable standard other than a USB terminal, or may be a terminal based on a unique standard.

The extension module 2 may be, as illustrated in FIG. 1, small in size and connected directly to the external terminal 101 to be held thereto. The extension module 2 may be supplied with electric power from the connected industrial equipment 1, via the external terminal 101. This is because, in this manner, when the extension module 2 is connected to the industrial equipment 1, it is not required to lay an extra cable or separately prepare a power cord, and the connection of the extension module 2 to the industrial equipment 1 can thus be simple. There are no technical restrictions on the size and shape of the extension module 2, and the extension module 2 is not limited to a stick-like shape illustrated in FIG. 1. For example, the extension module 2 may be a box-shaped case. Further, there is no problem in connecting the extension module 2 to the external terminal 101 of the industrial equipment 1 with the use of a cable, or in supplying electric power to the extension module 2 itself from a separate power source. For example, in a possible case in which the industrial equipment 1 is built into an interior of a device and it is difficult for an operator to directly access the industrial equipment 1, it is convenient to connect an appropriate extension cable to the external terminal 101 and connect the extension module 2 to the extension cable. Further, as described later, when electric power supplied from the external terminal 101 of the industrial equipment 1 is expected to be insufficient for the extension module 2, which has a high information processing capability and accordingly requires a large amount of electric power when computing as described later, it is recommended to arrange for separate supplying of electric power to the extension module 2.

In any case, the extension module 2 is connected directly to the external terminal 101 of the industrial equipment 1 when required, and is not connected to the industrial equipment 1 by virtual connection via a TCP/IP network or other general-purpose information communication networks. This is because the industrial equipment 1 in practice is, by nature, often built into some device to be used after being cut off from an outside general-purpose information communication network, due to security and other requirements.

The extension module 2 is an independent information processing device (namely, computer) on its own, and includes at least a processor and a memory therein. The industrial equipment 1 shown in this embodiment which is a servo controller also has functions as a servo amplifier and an information processing device including a processor and a memory to control the servo amplifier. However, as described above, the industrial equipment 1 is designed to have performance as an information processing device high enough to achieve aimed functions of the industrial equipment 1 in the first place. That is, as described in this embodiment, when the industrial equipment 1 is a servo controller, it is sufficient for the industrial equipment 1 to have an information processing capability high enough to control the controlled device 3, which is a servo motor, and, when the industrial equipment 1 is a PLC, it is sufficient for the industrial equipment 1 to have an information processing capability high enough for logical operation and input/output in units of several microseconds. Normally, the industrial equipment 1 is not prepared to have a computing capability that greatly exceeds those sufficient levels of information processing capability, for example, computing capability suitable for large-scale parallel computation. The extension module 2 includes a processor suitable for large-scale parallel computation and other types of heavy-load computation, and gives a computing capability that can handle the heavy processing load to the industrial equipment 1, which is not required to perform such computation in normal operation, on a temporary basis, that is, only when the extension module 2 is connected to the external terminal 101. The processor mounted in the extension module 2 may be a general (however, high in processing capability) central processing unit (CPU), a graphics processing unit (GPU) or a VPU, an application-specific integrated circuit (ASIC) or any other information processing circuit, or a combination of a plurality of types out of those types.

As described later, computation performed by the extension module 2 is mainly for what is called deep learning and other forms of machine learning in a multi-layer neural network. The extension module 2 therefore has a design suitable for computation in a machine learning model to be applied, and the design is normally parallel arrays of a large number of pipelines to enable the extension module 2 to process large-scale parallel computation at high speed. However, the extension module 2 can have any design as long as the design is suitable for machine learning of a machine learning model to be used.

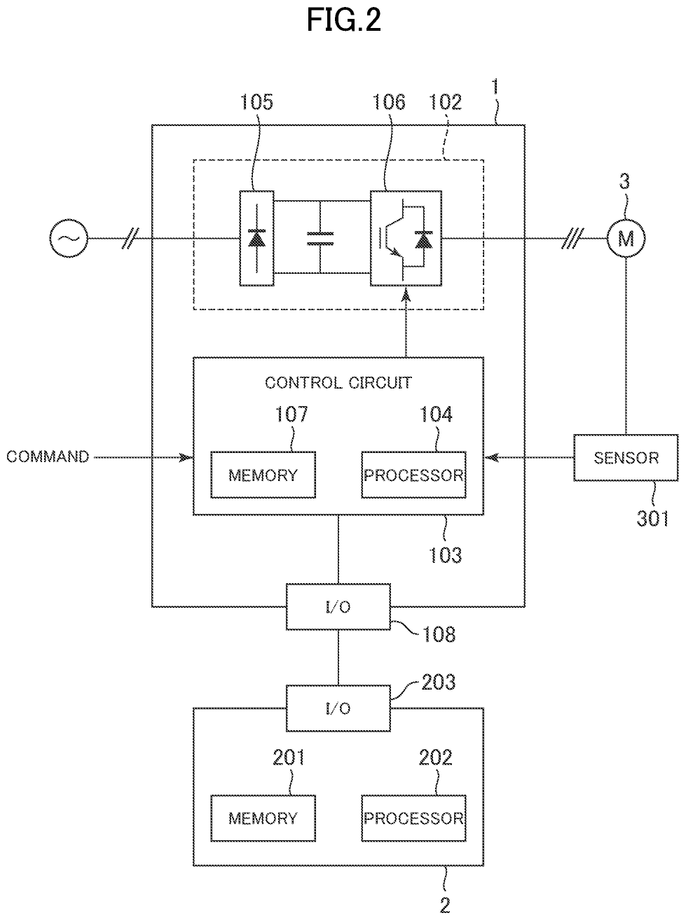

FIG. 2 is a schematic block diagram for illustrating hardware configurations of the industrial equipment 1, the extension module 2, and the controlled device 3. The industrial equipment 1 includes a servo amplifier 102 and a control circuit 103, controls an inverter 106 in response to a command received from an external device, converts a direct current converted by an AC/DC converter 105 into a three-phase alternating current suitable for driving of the controlled device 3, and outputs the alternating current. The command from the external device and output from a sensor 301 which detects a state of the controlled device 3 are input to the control circuit 103, and a processor 104 determines a control command to be issued to the inverter 106 based on various types of information stored in a memory 107.

“Sensor 301” is a collective term for all means for detecting information about the controlled device 3, and may include, when the controlled device is a servo motor as in this example, a rotation angle sensor, which is a rotary encoder or the like, a torque sensor, motor current means, a thermometer, and various other detectors.

The memory 107 stores various parameters to be used to control the controlled device 3, for example, a gain parameter, a constant or a time constant of a velocity, an acceleration rate, or the like that defines a velocity waveform of the motor, and a model constant of the controlled device 3. The memory 107 may also store other pieces of useful information, for example, a total drive amount in the form of an operation time, the total number of rotations, and the like of the controlled device 3, a model number or a serial number of the model, and information about a user. Those pieces of information may appropriately be referred to and used by the processor 104, depending on the type of the controlled device 3 and how the controlled device 3 is to be controlled. The memory 107 may further store, as described later, a learned machine learning model learned about the controlled device 3.

The industrial equipment 1 is provided with an I/O 108 as an interface to an external device. The external terminal 101 illustrated in FIG. 1 forms a part of the I/O 108. The I/O 108 includes one or a plurality of control circuits for information communication and one or a plurality of physical terminals, and the external terminal 101 is one of the physical terminals.

The extension module 2 includes a memory 201 and a processor 202, and the processor 202 can perform computation on its own by referring to the memory 201. The extension module 2 is also provided with an I/O 203 as an interface. The I/O 203 includes a control circuit for information communication and a physical terminal to connect to the external terminal 101 of the industrial equipment 1. In FIG. 2, a state in which the industrial equipment 1 and the extension module 2 are connected in a manner that allows information communication via the I/O 108 of the industrial equipment 1 and the I/O 203 of the extension module 2 is illustrated. The extension module 2 can receive, when it is required, information collected about the controlled device 3 from the sensor 301 via the industrial equipment 1 from the I/O 203.

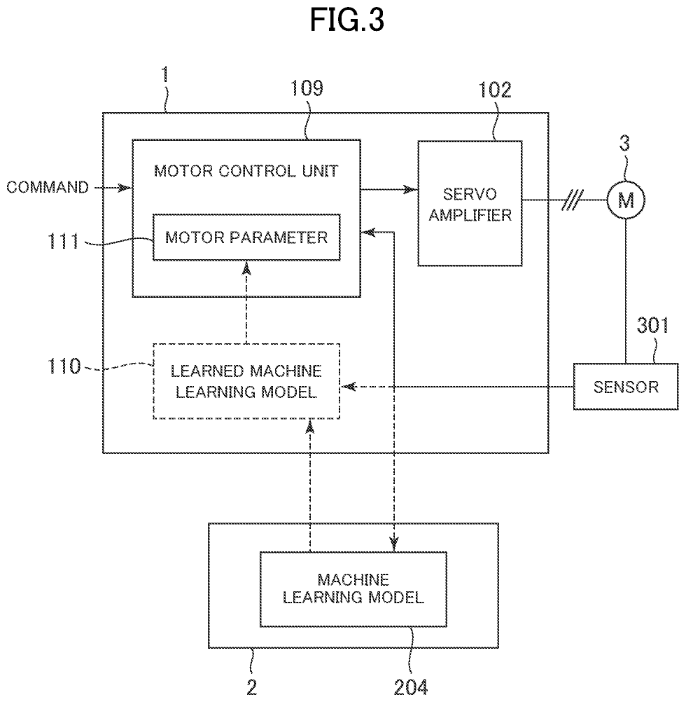

FIG. 3 is a function block diagram for illustrating internal configurations of the industrial equipment 1 and the extension module 2 connected to each other, with attention focused on functions of the industrial equipment 1 and the extension module 2.

The industrial equipment 1 includes a motor control unit 109, the servo amplifier 102, and, in some cases, a learned machine learning model 110. The motor control unit 109 is configured, in terms of hardware, mainly from the control circuit 103 illustrated in FIG. 2, and includes, in addition to the hardware component, control software stored in the memory 107 and a motor parameter 111 required for control of the controlled device 3, as main software components. The learned machine learning model 110 is stored in the memory 107 illustrated in FIG. 2. When the industrial equipment 1 is started to be used first, however, the learned machine learning model 110 is not prepared. As described later, the learned machine learning model 110 is subsequently constructed by executing machine learning with the use of the extension module 2 to be stored in the memory 107 of the industrial equipment 1. In FIG. 3, a part that is not prepared in the beginning and is to be acquired later, and an arrow indicating a flow of information exchanged in the acquisition are clearly illustrated by broken lines.

The extension module 2 includes a machine learning model 204. The extension module 2 is configured so that output from the sensor 301 can be input to the machine learning model 204.

A flow leading up to an ultimate goal which is constant control of the controlled device 3 by the industrial equipment 1 in the configurations illustrated in FIG. 1 to FIG. 3 is described.

In order to enable efficient, precise, and quick control of the controlled device 3 with the use of not only a motor controller but also various types of industrial equipment 1 other than a motor controller, it is required to give a parameter suitable for the mode of use of the controlled device 3. Many methods of estimating or automatically setting such a parameter have been proposed, and technologies for estimation or automatic setting of the parameter have been developed. However, the configuration, load, operation, and the like of the controlled device 3 all vary depending on each individual use, and, with a setting method that is uniform, a satisfactory parameter may not be obtained. There is also a case in which the environment of the use of the controlled device 3 changes from moment to moment. For example, when contents of work performed by a robot arm vary from work to work, or when a vehicle running in an outside environment experiences variations in the state of a road surface or goes through a change in payload, an optimum parameter naturally changes, and it is difficult to reset the parameter each time such a change occurs.

Significant internal states of the controlled device 3 including a physical change are difficult to measure directly. For example, it is difficult to find out wear, deterioration with age, and other similar states, and there is accordingly no choice but to perform maintenance in the form of replacement of parts for every fixed length of operation time, or the like. However, this means that parts that still have some lifetime left and do not require replacement are discarded, which increases maintenance cost and also decreases the length of time for which the device is in operation due to the time required for maintenance. It may not be impossible, under some conditions, to estimate the internal state of the controlled device 3 from output of a sensor provided in the controlled device 3. In most cases, however, the estimation from sensor output requires experience and intuition of a skillful operator and cannot be used on a wide scale. The estimation from sensor output is also not satisfactory in terms of reliability.

The indirect estimation of a favorable parameter of the industrial equipment 1, or an internal state of the controlled device 3, from output of a sensor provided in the controlled device 3 is predicted to be a strong point of machine learning, and the merit of utilizing machine learning for the estimation, if possible, is expected to be large.

Accordingly, when machine learning represented by deep learning is utilized for such use in this embodiment, the controlled device 3 is first caused to operate under a state in which the controlled device 3 is connected to the industrial equipment 1, and learning of the machine learning model 204 is executed by using information obtained from the sensor 301 as teacher data. The learned learning model 110 that is suited to an individual use and is highly precise can be obtained by advancing learning of the machine learning model 204 based on actual operation data of the controlled device 3 which is prepared for a specific use.

In obtaining the actual data of the controlled device 3 which serves as teacher data for the machine learning model 204 from the sensor 301, control itself for causing the controlled device 3 to operate is executed by the industrial equipment 1, but data obtained from the sensor 301 is sent to the extension module 2. The extension module 2 uses the processor 202 mounted in the extension module 2 to execute machine learning of the machine learning model 204 prepared in the memory 201 in advance.

What the machine learning model 204 is like is to be selected depending on the configuration of or the use of the controlled device 3, and is not particularly limited. When the machine learning model 204 is assumed to be a representative model called a deep neural network model, which has a multi-layer structure including, for example, about six to ten perceptron layers, computation required for machine learning of this model generally causes a heavy computing load, although depending on the number of nodes of the perceptron layers and the bit count of each of the nodes, and the computing capability of the processor of the industrial equipment 1 is insufficient for the computation. That is, the industrial equipment 1 is incapable of timely computation for sessions of machine learning to be learned one after another based on data obtained from the sensor 301 by causing the controlled device 3 to operate. Even when the industrial equipment 1 manages to obtain enough data, a huge amount of time is required to complete the learning, or a large memory capacity for holding data required for machine learning is temporally required. The computation in the machine learning is therefore executed with the use of the processor 202 mounted in the extension module 2 which has a higher computing capability. The computing capability of the processor 202 is recommended to be at, or above, a level high enough for enabling the machine learning model 204 to learn by processing pieces of data that are obtained from the sensor 301 one after another in real time, or without much delay from a rate at which the pieces of data are obtained.

The machine learning model 204 is prepared and held in the memory 201 of the extension module 2 in advance as a model suitable for the configuration of the controlled device 3 expected to be used by the industrial equipment 1. The machine learning model 204 may be prepared by an operator who is planning to perform machine learning as a model suitable for the configuration of or the use of the controlled device 3, or a plurality of types of the machine learning model 204 may be stored in the memory 201 of the extension module 2 in advance so that the most suitable type of the machine learning model 204 is simply selected.

The operator may prepare the machine learning model 204 by, for example, selecting a machine learning model closest to the configuration of or the use of the controlled device 3 to be used from among a plurality of machine learning models provided via the Internet or the like, downloading the selected model in advance to a PC or a similar information processing device, and connecting the extension module 2 to the information processing device to transfer the downloaded machine learning model 204 to the memory 201. In this manner, the operator is not required to build the machine learning model 204 by himself or herself, and can use machine learning without being proficient in AI technology.

In the case in which a plurality of types of the machine learning model 204 are stored in the memory 201 of the extension module 2 in advance, the operator may specify one of the plurality of types. Alternatively, the extension module 2 or the industrial equipment 1 may automatically select one type of the machine learning model 204 based on information that indicates the configuration of the controlled device 3 connected to the industrial equipment 1, for example, the model number or the serial number of the controlled device 3. In this manner, the machine learning model 204 suitable for the configuration of or the use of the controlled device 3 is automatically selected without requiring the operator to have abundant knowledge on AI technology.

The number of the types of the machine learning model 204 to be selected when machine learning is performed is not limited to one, and a plurality of types of the machine learning model 204 may be selected. In this case, the extension module 2 simultaneously performs machine learning for the selected plurality of types of the machine learning model 204 in parallel, and may select and use a version with the highest score (in terms of, for example, prediction precision) out of ultimately obtained versions of the machine learning model 204. In this case, although the processor 202 of the extension module 2 is required to have a computing capability high enough to simultaneously perform machine learning for a plurality of types of the machine learning model 204, a probability of obtaining a highly precise learned machine learning model increases.

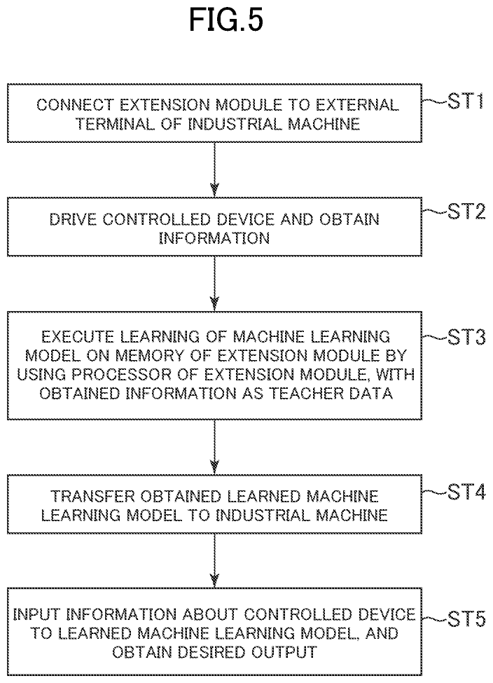

Steps from performing of machine learning to estimation of a parameter of the industrial equipment 1, or estimation of an internal state of the controlled device 3 is described as follows with reference to the flow chart illustrated in FIG. 5. When the controlled device 3 is connected to the industrial equipment 1 and a learned machine learning model is not obtained yet, the extension module 2 is connected first to the external terminal 101 of the industrial equipment 1 (Step ST1). Subsequently, the controlled device 3 is driven in order to obtain data required for machine learning, and information about the controlled device 3 is obtained from the sensor 301 (Step ST2). With the obtained information as teacher data, machine learning of a machine learning model stored in the memory 201 is executed by using the processor 202 of the extension module 2 (Step ST3).

When the machine learning advances enough, the learned machine learning model 110 is obtained in the memory 201 of the extension module 2. The learned machine learning model 110 is transferred to and stored in the memory 107 of the industrial equipment 1 (Step ST4). The industrial equipment 1 thus comes to include the learned machine learning model 110 learned about the specific controlled device 3, without relying on its own processor 104.

The learned machine learning model 110 is a model to which information obtained from the sensor 301 is input and from which some desired information is output. A desired output is accordingly obtained by appropriately inputting the information obtained from the sensor 301 about the controlled device 3 to the learned machine learning model 110 (Step ST5). The output information may be one or a plurality of parameters to be used in the industrial equipment 1, or one or a plurality of estimation values of an internal state of the controlled device 3, or both thereof.

To give a more specific example, with an operation waveform of a velocity, a torque, a current, or the like of the controlled device 3, which is a servo motor, as input, the learned machine learning model 110 that outputs a gain parameter suitable for control, or that estimates a sign of wear and deterioration with age at an early stage and outputs a warning signal prompting the operator to execute inspection or replacement of parts, or estimates a lifetime remaining until occurrence of a failure, can be built.

The learned machine learning model 110 is stored in the memory 107 of the industrial equipment 1 in this embodiment. Accordingly, the estimation of a parameter of industrial equipment or an internal state of a device controlled by the industrial equipment with the use of the learned machine learning model 110 does not require the extension module 2.

The extension module 2 is therefore not required to be connected all the time and can be kept detached when the industrial equipment 1 is routinely used.

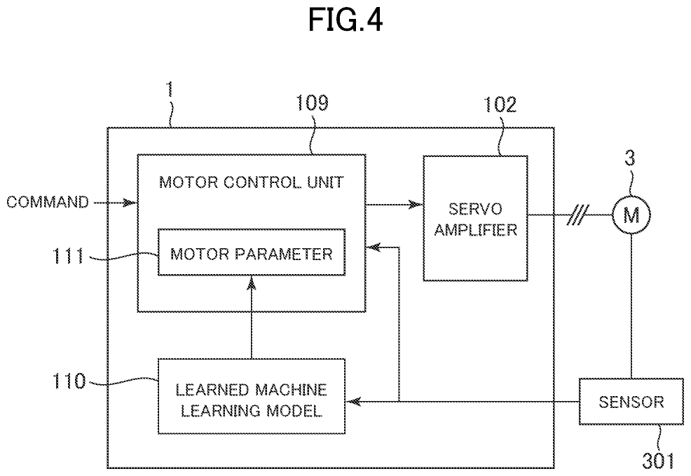

FIG. 4 is a function block diagram for illustrating an internal configuration of the industrial equipment 1, with the learned machine learning model 110 included therein. In the state in which the industrial equipment 1 has acquired the learned machine learning model 110, as illustrated in FIG. 4, the learned machine learning model 110 can be used to estimate a favorable parameter, or estimate an internal state of the controlled device 3, when required, without the extension module 2 being connected.

The learned machine learning model 110 is typically a deep neural network model having multiple perceptron layers as well, and requires a considerable amount of computation in order to output in response to an input value. However, the required amount of computation is small compared to execution of machine learning, and estimation values to be obtained with the use of the learned machine learning model 110 are not required to be obtained in real time or with urgency in many cases. It is therefore considered that a satisfactory level of practical utility is secured with computation that is performed by using excess the computing capability of the processor 104 in an interval in normal control of the controlled device 3 or other occasions.

As described above, the extension module 2 is not always required in routine operation and hence, even in a case of, for example, running a large number of industrial equipment 1, it is sufficient to temporarily connect the extension module 2 only to the industrial equipment 1 for which machine learning is to be performed. A single extension module 2 can thus be used by a plurality of industrial equipment 1, which is economical.

As described above, this embodiment uses the learned machine learning model 110 to output a gain parameter suitable for control, or estimate a sign of wear and deterioration with age at an early stage for the purpose of outputting a warning signal prompting the operator to execute inspection or replacement of parts, or estimating a lifetime remaining until occurrence of a failure. However, when the controlled device 3 is caused to operate in order to obtain teacher data for machine learning, a learning effect is difficult to achieve and efficiency of learning is not so high as well for an event that occurs infrequently.

The machine learning model 204 stored in the memory 201 of the extension module 2 is therefore recommended to be an intermediate learning model which has finished learning to a certain degree in advance, based on the configuration of the industrial equipment 1 and the configuration of the controlled device 3 controlled by the industrial equipment 1. This is utilization of a machine learning method called “transfer learning,” and refers to the use of, as the machine learning model 204, a learning model that has finished in advance an intermediate level of learning by means of a representative configuration close to the configuration of the expected controlled device 3, and learning with respect to an infrequently occurring event. The machine learning model 204 that has finished the intermediate learning is high in the efficiency of learning and can be enhanced early in precision. The use of the machine learning model 204 that has finished the intermediate learning also mitigates a problem of overfitting due to overtraining, and provides the learned machine learning model 110 capable of correct estimation even for an infrequently occurring event, which is not much likely to be included in teacher data obtained from the industrial equipment 1 and the controlled device 3 controlled by the industrial equipment 1.

Possible examples of an infrequently occurring event include wear, deterioration with age, and other troubles accompanying long-term operation of the controlled device 3, signs of those troubles, catching of foreign objects, breakage, and other accidental events. Learning with respect to such events is considered to be difficult particularly by machine learning using the industrial equipment 1 and the controlled device 3 that are brand-new. The use of an intermediate learning model as the machine learning model 204 therefore has a great merit.

Recommended timing at which the industrial equipment 1 illustrated in FIG. 4 estimates a parameter of the industrial equipment 1 or estimates an internal state of the controlled device 3 with the use of the learned machine learning model 110 is a time when a specific state of the industrial equipment 1 is detected or a time when an elapse of a fixed length of time is detected.

As a first example, a possible case in which estimation of the parameter is required is a case in which a state of the controlled device 3 connected to the industrial equipment 1, for example, the magnitude of a load, changes. In that case, some physical change is considered to have been applied to the configuration of a device itself that uses the industrial equipment 1. Such a change is generally made when the device is stopped and stationary, and estimation of the parameter is therefore possibly performed when, for example, powering on or off of the industrial equipment 1 is detected. Other examples of the case in which a specific state of the industrial equipment 1 is detected include a case in which a change exceeding a given level is detected in the load of the controlled device 3 and a case in which a change to contents of control of the controlled device 3 is detected, and the estimation of the parameter or the internal state of the controlled device 3 is recommended to be executed in those cases.

As a second example, it is considered to be enough to execute the estimation of the parameter or an internal state of the controlled device 3 each time an elapse of a fixed length of time, for example, 24 hours, is detected, because troubles due to a characteristics change, wear, and deterioration accompanying continuous use of the controlled device 3, and signs of the troubles, are not likely to be detected suddenly. The fixed length of time in this case may be measured by elapse of actual time, a length of time in which the industrial equipment 1 is kept powered on, or elapse of an accumulated amount of time in which the controlled device 3 is in operation.

Thus, the estimation of the parameter or an internal state of the controlled device 3 can be executed without applying unrequired load on the processor 104 of the industrial equipment 1 by estimating the parameter or an internal state of the controlled device 3 in the case of detecting a specific state of the industrial equipment 1, or in the case of detecting an elapse of a fixed length of time, or in both of the cases.

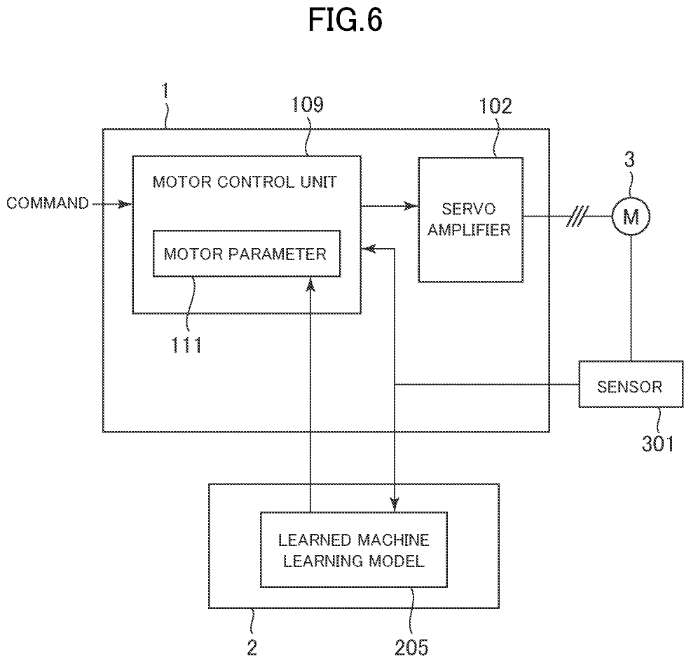

FIG. 6 is a diagram for illustrating the industrial equipment 1 and the extension module 2 according to a second embodiment of the present invention, and is a diagram for illustrating function blocks in a state in which the industrial equipment 1 and the extension module 2 are connected to each other.

In this embodiment, physical configurations of the industrial equipment 1, the extension module 2, and the controlled device 3 are the same as the physical configurations in the preceding embodiment, and functions thereof are also basically the same as the functions in the preceding embodiment. Components common to the two embodiments are therefore denoted by the same reference numerals, and duplicate descriptions are omitted. FIG. 1 and FIG. 2, which are illustration of the preceding embodiment, are referred to in this embodiment as well.

This embodiment is exactly the same as the preceding embodiment up through the point at which machine learning is executed for the machine learning model stored in the memory 201 of the extension module 2. That is, of the steps illustrated in the flow chart of FIG. 5, the step of connecting the extension module 2 to the external terminal 10 of the industrial equipment 1 (Step ST1), the step of driving the controlled device 3 and obtaining information from the sensor 301 (Step ST2), and the step of executing, with the obtained information as teacher data, learning of the machine learning model 204 on the memory 201 of the extension module 2, by using the processor 202 of the extension module 2 (Step ST3) are the same. In this embodiment, however, an ultimately obtained learned machine learning model 205 continues to be kept in the memory 201 of the extension module 2.

Accordingly, the estimation of a parameter of the industrial equipment 1 or an internal state of the controlled device 3 which is executed by the industrial equipment 1 at appropriate timing (the timing already described in the first embodiment applies) is executed under a state in which the industrial equipment 1 and the extension module 2 are connected as illustrated in FIG. 6.

In this embodiment, the extension module 2 is required to be connected to the external terminal 101 of the industrial equipment 1 when a parameter of the industrial equipment 1 or an internal state of the controlled device 3 is estimated. This embodiment, however, is advantageous in that the memory 107 of the industrial equipment 1 can have a small capacity because the learned machine learning model 205, which has a large amount of information, is not required to be held in the memory 107 of the industrial equipment 1. Another advantage is that estimation values of a parameter of the industrial equipment 1 and an internal state of the controlled device 3 can be obtained quickly particularly when the processor 104 of the industrial equipment 1 has a low computing capability, without applying an extra load to the processor 104 of the industrial equipment 1, because computation itself for the estimation of a parameter of the industrial equipment 1 and an internal state of the controlled device 3 itself is executed by the processor 202 mounted in the extension module 2, which has an excellent computing capability.

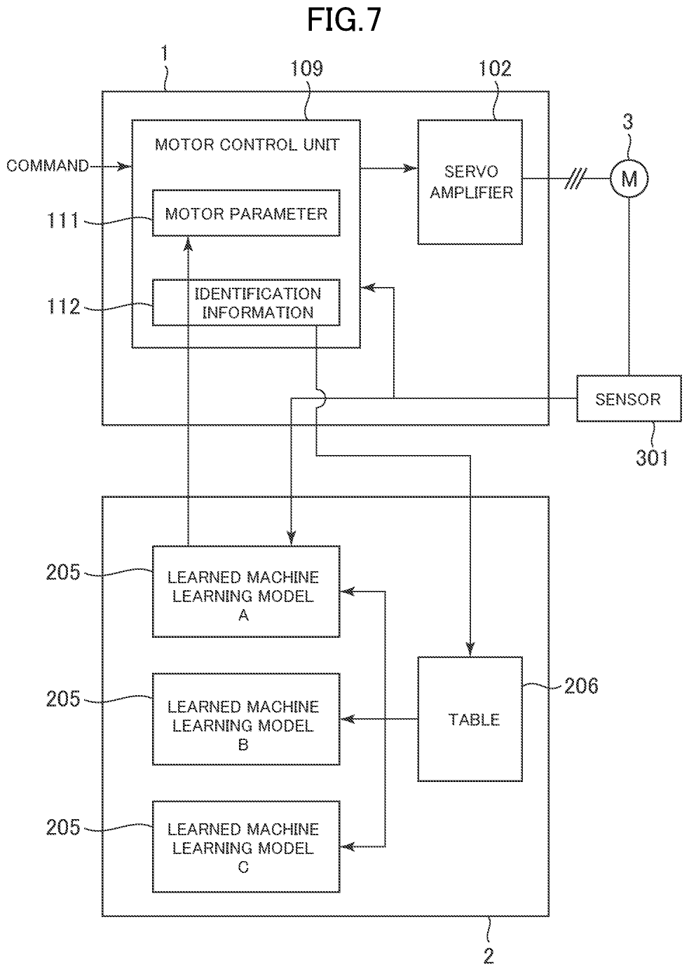

FIG. 7 is a diagram for illustrating the industrial equipment 1 and the extension module 2 according to a third embodiment of the present invention, and is a diagram for illustrating function blocks in a state in which the industrial equipment 1 and the extension module 2 are connected to each other.

In this embodiment, physical configurations of the industrial equipment 1, the extension module 2, and the controlled device 3 are also the same as the physical configurations in the preceding embodiments, and functions thereof are also basically the same as the functions in the preceding embodiments. Components common to the embodiments are therefore denoted by the same reference numerals, and duplicate descriptions are omitted. FIG. 1 and FIG. 2, which are illustration of the preceding embodiments, are referred to in this embodiment as well.

This embodiment is common with the preceding first embodiment and second embodiment in that machine learning of a machine learning model stored in the memory 201 of the extension module 2 is executed with the extension module 2 connected to the external terminal 101 of the industrial equipment 1. The obtained learned machine learning model 205 is held in the memory 201 of the extension module 2 as in the second embodiment.

In this embodiment, as illustrated in FIG. 7, a plurality of types of the learned machine learning model 205 may be held in the memory 201 of the extension module 2. The memory 201 also holds, for each type of the learned machine learning model 205, information for identifying which industrial equipment 1 has been connected when the type of the learned machine learning model 205 is obtained so that, for each of the plurality of types of the learned machine learning model 205, which industrial equipment 1 is associated with the type of the learned machine learning model 205 is identifiable.

That a specific learned machine learning model 205 is associated with a specific industrial equipment 1 means a situation that the industrial equipment 1 has collected teacher data by connecting the extension module 2 thereto and driving the controlled device 3 when machine learning for obtaining the learned machine learning model 205. The information for identifying the industrial equipment 1 may be any kind of information as long as the industrial equipment 1 can uniquely be identified. The identification information in this embodiment is a table 206 in which an association relationship between a serial number of an industrial equipment 1 and an obtained learned machine learning model is held.

That is, in this embodiment, when machine learning of the machine learning module 204 is executed by connecting the industrial equipment 1 and the extension module 2 to each other, identification information 112 stored in the industrial equipment 1 is transmitted to the extension module 2 to store an association relationship with the machine learning model 204 for which learning is being executed in the table 206. The timing of transmission of the identification information 112 to the extension module 2 may be any point during a period in which the machine learning is executed, and the identification information 112 may be transmitted at the beginning of the machine learning, or at the time when the machine learning is completed and the learned machine learning model 205 is obtained, or later.

The extension module 2 is not always used by one specific industrial equipment 1 alone, and is used by a plurality of industrial equipment 1. That is, the extension module 2 is temporarily connected to a specific industrial equipment 1, and is later disconnected to be connected to another industrial equipment 1. For each industrial equipment 1 to which the extension module 2 is connected, the learned machine learning model 205 is created and stored in the memory 201 of the extension module 2 until a storage capacity of the memory 201 is exhausted. In FIG. 7, an example in which three learned machine learning models A to C are held is illustrated.

In order to estimate an internal parameter of one industrial equipment 1, or an internal state of the controlled device 3 connected to the industrial equipment 1, a type of the learned machine learning model 205 obtained in association with the industrial equipment 1 is required. Thus, when the internal parameter or an internal state of the controlled device 3 is estimated, the extension module 2 that already holds the learned machine learning model 205 in the memory 201 is connected to the external terminal 101 of the industrial equipment 1.

When the industrial equipment 1 is instructed, by a direct command or an indirect command via an external device, to estimate the internal parameter or an internal state of the controlled device 3 connected to the industrial equipment 1, information obtained by the sensor 301 about the controlled device 3 and the identification information 112 of the industrial equipment 1 are sent to the extension module 2.

The processor 202 of the extension module 2 refers to the table 206 to compare the identification information 112 sent thereto, and identifies a type of the learned machine learning model 205 that has been obtained in association with the currently connected industrial equipment 1. Here, the learned machine learning model A is the identified learned machine learning model 205.

The processor 202 inputs the information about the controlled device 3 sent thereto to the learned machine learning model A, and transmits resultant desired output to the industrial equipment 1. The processor 104 of the industrial equipment 1 executes processing appropriate for the type and contents of the resultant output. In the example illustrated in FIG. 7, output from the learned machine learning model A is an estimation value of the motor parameter 111, which is an internal parameter of the industrial equipment 1, and the processor 104 accordingly updates the motor parameter 111 with the output. The processor 104 executes processing suitable for output from the learned machine learning model A in other cases as well, for example, presenting information based on an estimation value of the internal state to the operator when the resultant output is an estimation value of the internal state.

In this manner, the memory 201 of the extension module 2 is designed so as to be capable of storing a plurality of types of the learned machine learning model 205, and which learned machine learning model 205 is to be used to estimate a parameter of the industrial equipment 1 to which the extension module 2 is connected, or an internal state of the controlled device 3 connected to the industrial equipment 1, is selected based on the identification information 112 of the industrial equipment 1. The estimation of the parameter or an internal state of the device can thus appropriately be executed for a plurality of industrial equipment 1, with a single extension module 2, by simply connecting the extension module 2 to the external terminal 101 of the industrial equipment 1, without relearning.

In the description of this embodiment, the selection of the learned machine learning model 205 is automatically executed based on the identification information 112 of the industrial equipment 1. However, the operator who is a user may explicitly select which learned machine learning model 205 is to be used.

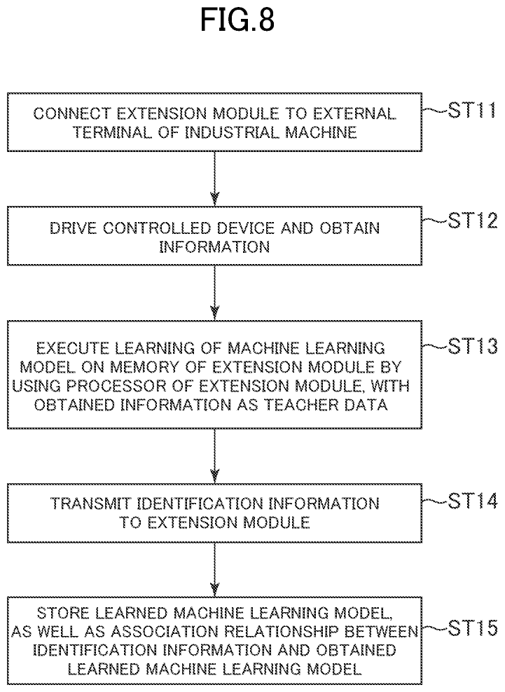

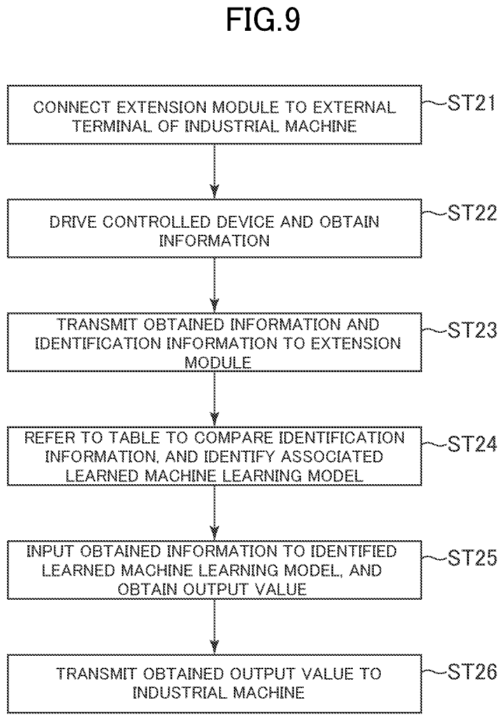

The third embodiment is described, with reference to flow charts illustrated in FIG. 8 and FIG. 9, through a description on a flow of the learning of the machine learning model 204 and a flow of estimating the parameter and an internal state of the device with the use of the learned machine learning model 205.

FIG. 8 is a flow chart for illustrating steps of executing learning of the machine learning model 204 in the third embodiment.

First, the extension module 2 is connected to the external terminal 101 of the industrial equipment 1 (Step ST11). At this stage, machine learning of the machine learning model 204 held in the memory 201 of the extension module 2 is not executed yet. However, the machine learning model 204 may be an intermediate learning model as already described.

The industrial equipment 1 drives the controlled device 3 and obtains information to serve as teacher data from the sensor 301 (Step ST12). Further, the obtained information is transmitted to the extension module 2, and the processor 202 of the extension module 2 executes machine learning of the machine learning model 204 with the obtained information as teacher data, and obtains the learned machine learning model 205 (Step ST13).

The industrial equipment 1 transmits the identification information 112 of itself to the extension module 2 (Step ST14). The timing of transmission of the identification information 112 may be at an earlier stage, for example, immediately after the extension module 2 is connected to the external terminal 101 of the industrial equipment 1 in Step ST11.

Lastly, an association relationship between the obtained learned machine learning model 205 and the identification information 112 is stored in the memory 201 (Step ST15). In the example illustrated in FIG. 7, the association relationship is stored in the form of a table.

FIG. 9 is a flow chart for illustrating steps of estimating the parameter or an internal state of the device with the use of the learned machine learning model 205 in the third embodiment.

First, when the extension module 2 is not connected yet, the extension module 2 is connected to the external terminal 101 of the industrial equipment 1 (Step ST21). Here, the connected extension module 2 has undergone machine learning executed with the use of the industrial equipment 1 by the steps illustrated in FIG. 8, and already stores a type of the learned machine learning model 205 that is associated with the industrial equipment 1 in the memory 201.

Subsequently, the industrial equipment 1 drives the controlled device 3 and obtains information from the sensor 301 (Step ST22). The obtained information and the identification information 112 of the industrial equipment 1 itself are transmitted to the extension module 2 (Step ST23).

The processor 202 of the extension module 2 identifies the associated learned machine learning model 205 based on the received identification information 112 (Step ST24). The processor 202 further inputs the transmitted information to the identified learned machine learning model 205 to obtain desired output (Step ST25).

The extension module 2 transmits the obtained output value to the industrial equipment 1 (Step ST26). The processor 104 of the industrial equipment 1 executes processing determined based on a type and a magnitude of the received output value.

In the embodiments described above, the operator prepares the machine learning model 204 (including an intermediate learning model) suitable for the type, for example, model type, of the industrial equipment 1 to be used, or suitable for the configuration of the controlled device 3 connected to the industrial equipment 1, or a suitable machine learning model is explicitly or automatically selected from a plurality of types of the machine learning model 204 stored in the extension module 2 in advance.

However, when a favorable machine learning model 204 is to be prepared for each of various configurations of the controlled device 3 and an applicable intermediate learning model is to be prepared for each use of the controlled device 3, the number of types of the machine learning model 204 to select from is large in some cases. In such cases, it is not advisable to store all of many types of the machine learning model 204 in the memory 201 of the extension module 2 in advance from the viewpoint of the capacity of the memory 201, and it is also considered to be difficult to select an optimum model from many types of the machine learning model 204 unless the operator is skilled.

An embodiment having a configuration in which a favorable model is automatically selected and obtained from many types of the machine learning model 204 including intermediate learning models is described below as a fourth embodiment of the present invention.

In the fourth embodiment of the present invention as well, the industrial equipment 1, the extension module 2, and the controlled device 3 have the same physical configurations as the physical configurations in the preceding embodiments, and have functions that are basically the same as the functions in the preceding embodiments. Components common to the fourth embodiment and the preceding embodiments are therefore denoted by the same reference numerals, and duplicate descriptions are omitted. Further, FIG. 1 and FIG. 2, which are illustration of the preceding embodiments, are referred to in this embodiment as well. The fourth embodiment may also use the steps of machine learning of the machine learning model 204 and the step of estimating a parameter of the industrial equipment 1 or an internal state of the controlled device 3 in one of the first to third embodiments described above.

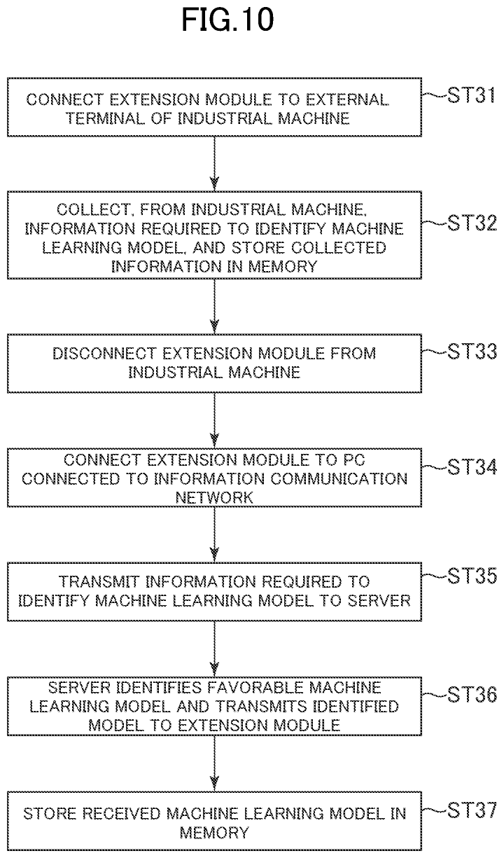

A flow of selecting and obtaining the machine learning model 204 in this embodiment is described below with reference to a flow chart illustrated in FIG. 10. In the beginning, no learned machine learning model is obtained yet for the industrial equipment 1 to which a specific controlled device 3 is connected, and a type of the machine learning model 204 suitable for the configuration of the controlled device 3 is also not identified yet. In this state, the operator first connects the extension module 2 to the external terminal 101 of the industrial equipment 1 (Step ST31).

In the memory 201 of the extension module 2 at this point, no machine learning model 204 is stored, or some types of the machine learning model 204 (for example, frequently used types) are stored but a type of the machine learning model 204 suitable for the assumed configuration is not stored.

In this case, the extension module 2 collects information required to identify the machine learning model 204 from the industrial equipment 1, and stores the information in the memory 201 (Step ST32). The information required to identify the machine learning model 204 includes information about the industrial equipment and information about the controlled device, more specifically, information for identifying the industrial equipment 1 and information for identifying the controlled device 3 and the configuration of the controlled device 3. The information for identifying the industrial equipment 1 may be the model number of the industrial equipment 1 or the like. The information for identifying the controlled device 3 and the configuration thereof may be the model number of the controlled device 3 and information indicating performance, for example, a capacity of the motor, information indicating a use or a combination of the controlled device 3, and information indicating performance to be accomplished.

The operator then disconnects the extension module 2 from the industrial equipment 1 once (Step ST33), and connects the extension module 2 to a computer connected to an external information communication network, which is the Internet or the like (Step ST34). The extension module 2 transmits the collected information required to identify the machine learning model 204 via the external information communication network to a server connected to the information communication network (Step ST35).

The server to which the collected information is transmitted stores many types of machine learning models including intermediate learning models. The server selects a favorable machine learning model based on the received information, and transmits the selected machine learning model to the extension module 2 (Step ST36).

The extension module 2 stores the machine learning model 204 transmitted from the server in the memory 201 (Step ST37).

Subsequently, machine learning of the machine learning model 204 may be executed by the same steps as the steps described in the preceding first to third embodiments, and a parameter in the industrial equipment 1, or an internal state of the controlled device 3, may be estimated.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An extension module to be connected to an external terminal of a first piece of industrial equipment, the extension module comprising:
at least a processor and a memory,
wherein the memory is configured to store a machine learning model for estimating at least one parameter of the first piece of industrial equipment or estimating an internal state of a device controlled by the first piece of industrial equipment, and
wherein the processor is configured to perform learning of the machine learning model with information obtained from the first piece of the industrial equipment as teacher data.

2. The extension module according to claim 1, wherein the processor is configured to input, as input data, information obtained from the first piece of industrial equipment to the trained machine learning model, and obtain, as an output, an estimation value of the parameter of the first piece of industrial equipment or an estimation value of the internal state of the device controlled by the first piece of industrial equipment.

3. The extension module according to claim 2, wherein the processor is configured to obtain an estimation value of the parameter of the first piece of industrial equipment or an estimation value of the internal state of the device controlled by the first piece of industrial equipment as an output, when at least one of two conditions are satisfied, a first condition being an elapse of a fixed period and a second condition being detection of a specific state of the first piece of industrial equipment.

4. The extension module according to claim 1, wherein the processor is configured to transmit the trained machine learning model to the first piece of industrial equipment.

5. The extension module according to claim 2,
wherein the memory is configured to store a plurality of types of the trained machine learning model finished, and
wherein the processor is configured to select the machine learning model to be used for estimation of the parameter of the first piece of industrial equipment or the internal state of the device controlled by the first piece of industrial equipment, based on at least one of a specification by a user or identification information of the first piece of industrial equipment to which the extension module is connected.

6. The extension module according to claim 1, wherein the processor is configured to select one machine learning model from a plurality of machine learning models based on at least one of a specification by a user or information about a device controlled by the first piece of industrial equipment.

7. The extension module according to claim 6, wherein the memory is configured to store the plurality of machine learning models.

8. The extension module according to claim 7, wherein the processor is configured to obtain one machine learning model from a plurality of machine learning models stored in an external server, based on information that is collected about a device controlled by the first piece of industrial equipment.

9. The extension module according to claim 1,
wherein the machine learning model is an intermediate learning model for which intermediate learning is executed in advance, and
wherein the processor is configured to execute learning of the machine learning model by transferring learning using the intermediate learning model.

10. A first piece of industrial equipment, comprising:
an industrial equipment-side memory configured to store a trained machine learning model which is transmitted from the extension module,
wherein the first piece of industrial equipment is configured to input information of the first piece of industrial equipment itself to the trained machine learning model as input data, and obtain, as an output, an estimation value of a parameter of the first piece of industrial equipment or an estimation value of an internal state of a device controlled by the first piece of industrial equipment.

11. The first piece of industrial equipment according to claim 10, wherein the first piece of industrial equipment is configured to obtain an estimation value of the parameter of the first piece of industrial equipment or an estimation value of the internal state of the device controlled by the first piece of industrial equipment as an output, when at least one of two conditions are satisfied, a first condition being an elapse of a fixed period and a second condition being detection of a specific state of the first piece of industrial equipment.

12. A method of estimating a parameter of a first piece of industrial equipment or an internal state of a device controlled by the first piece of industrial equipment, the method comprising:
connecting an extension module to an external terminal of the first piece of industrial equipment, the extension module including at least a processor and a memory; and
executing a machine learning method in which the processor executes learning of a learning model stored in the memory to estimate at least one of the parameter of the first piece of industrial equipment or the internal state of the device controlled by the first piece of industrial equipment, with information obtained from the first piece of industrial equipment as teacher data.

13. The method of estimating a parameter of the first piece of industrial equipment or the internal state of a device controlled by the first piece of industrial equipment according to claim 12, further comprising:
inputting, by the processor, as input data, information obtained from the first piece of industrial equipment to the learning model finished with learning, and obtaining, as an output, an estimation value of the parameter of the first piece of industrial equipment or an estimation value of the internal state of the device controlled by the first piece of industrial equipment.

14. The method of estimating a parameter of the first piece of industrial equipment or the internal state of a device controlled by the first piece of industrial equipment according to claim 12, further comprising:
transmitting, by the processor, the trained learning model to the first piece of industrial equipment; and
inputting, by the first piece of industrial equipment, information of the first piece of industrial equipment itself to the trained learning model as input data, and obtaining, as an output, an estimation value of the parameter of the first piece of industrial equipment or an estimation value of the internal state of the device controlled by the first piece of industrial equipment.
